(19) United States
(12) Patent Application Publication
(10) Pub. No.: US 2002/0135466 A1
(43) Pub. Date: Sep. 26, 2002

(54) Vehicle security system and method

(76) Inventor: Roy James Bunyan, Hook (GB)

Correspondence Address: Lee, Mann Smith, McWilliams, Sweeney & Ohlson, P.O. Box 2786, Chicago, IL, 60690-2786, US

(21) Appl. No.: 10/075,646

(22) Filed: Feb. 14, 2002

(30) Foreign Application Priority Data
Mar. 21, 2001 (GB) GB 0107035.8

(51) Int. Cl. B60R 25/10

(52) U.S. Cl. 340/426; 340/539

(57) ABSTRACT

A vehicle security system uses a portable device such as a pocket PC or PDA. When the device is inserted in a cradle in the vehicle, it communicates with the on-board computer to obtain the vehicle identity. The device then sends a request message, containing the vehicle identity and device identity, to a remote authentication server. The authentication server performs a number of checks, including checking that the device is authorized for use with this vehicle, and returns a response to the device. If the authentication is successful, the device allows the vehicle to be started. If the response from the authentication server is delayed, the vehicle may be started, but if the authentication check then fails, an on-line check will be compulsory the next time an attempt is made to start the vehicle.

### BACKGROUND TO THE INVENTION

This invention relates to a system and method for improving vehicle security.

Conventionally, vehicle security systems have relied on keys to lock/unlock doors and to control the vehicle ignition system. Remote control units (either infrared or radio frequency) have also been used, to control door locks or to enable/disable an engine immobilizer.

With these conventional systems, a driver can only use the vehicle for which he or she holds the appropriate key or remote control unit. However, especially in the context of a fleet management system, it may be desired from time to time to vary the permissions for drivers to use vehicles. For example, it may be required to permit a driver to use a different vehicle (either temporarily or permanently), or to prevent a driver from using a particular vehicle, or to allow a driver to use more than one vehicle. This cannot be achieved easily with conventional systems.

The object of the invention is to provide a vehicle security system and method in which this problem is alleviated.

### SUMMARY OF THE INVENTION

According to the invention a vehicle security method comprises: (a) operating a portable device in the vehicle to obtain the identity of the vehicle, and then to send a message by a wireless connection to a remote authentication server computer, the message including the identity of the vehicle and also the identity of the portable device; (b) operating the authentication server computer to perform a check that the portable device is authorized in relation to the vehicle, and then to return a response by the wireless connection to the portable device, indicating the result of the check; and (c) operating the portable device, when it receives the response from the authentication server computer, and if the response indicates that the result of the check is satisfactory, to enable the vehicle to be started.

It can be seen that, in the present invention, checks for vehicle authorization are carried out in a remote authentication server computer. Hence, permissions for drivers to use vehicles can be changed centrally at the authentication server, without the necessity for exchanging or recalling the individual devices.

The authentication server computer may also perform other checks, beyond merely checking that the portable device is authorized for to this vehicle, as will be described.

### BRIEF DESCRIPTION OF THE DRAWINGS

FIG. 1 is a block diagram of a vehicle security system embodying the present invention.

FIG. 2 is a flow chart showing the operation of a portable device used in the vehicle security system.

### DESCRIPTION OF AN EMBODIMENT OF THE INVENTION

One vehicle security system and method embodying the invention will now be described by way of example with reference to the accompanying drawings.

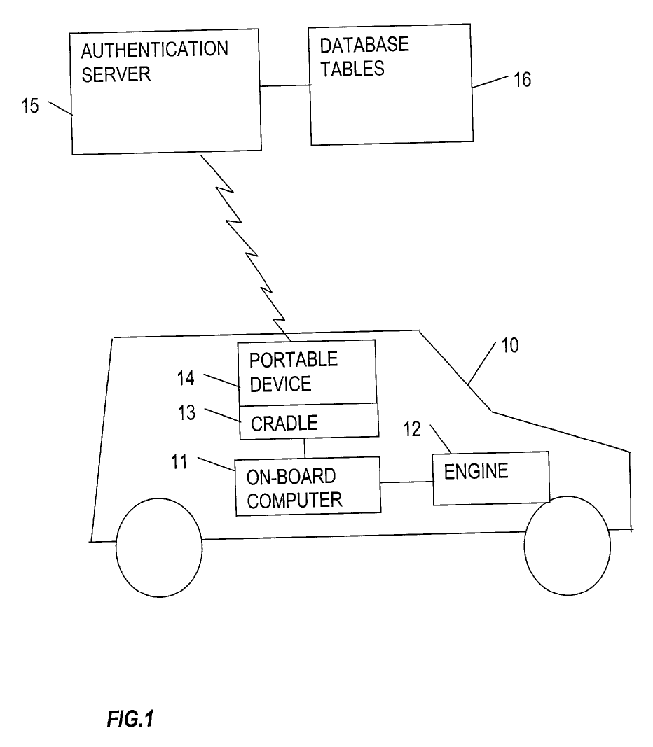

FIG. 1 shows a vehicle 10, having an on-board computer 11 which controls a number of systems in the vehicle, including the vehicle engine 12. The vehicle also includes a cradle 13, mounted for example on the vehicle dashboard. The cradle is adapted to receive a portable device 14, such as a pocket PC (personal computer) or PDA (personal digital assistant). When the portable device 14 is inserted into the cradle, it is connected to the on-board computer 11 by way of a data link. The cradle also supplies electrical power to the portable device.

When not in use in connection with the vehicle, the portable device 14 can be removed from its cradle and carried around by the user, for use in the normal manner as a pocket PC or PDA.

The portable device 14 includes a GPS (Global Positioning System) receiver, which supplies the portable device with data indicating its current position e.g. as latitude and longitude values.

The portable device 14 also includes a cellular wireless transmitter/receiver circuit, through which it can send or receive messages and e-mails in the conventional manner. In particular, this enables the portable device to communicate with a remote authentication server computer 15.

The authentication server computer 15 can access a number of database tables 16, which hold information on:

Which portable devices are authorized for use with which vehicles.

The identities of any vehicles reported as being stolen.

The time slots (if any) within which each vehicle may be used with each portable device.

The geographical area within which each vehicle may be used with each portable device.

Information about the driving documentation held by each device owner (e.g. driving licence, insurance, vehicle licence, and vehicle test certificate), including whether the documentation is valid and the expiry date of each document.

An “authentication mandatory” flag for each vehicle. When set, this indicates that it is not permissible to start the vehicle without first receiving a successful response from the authentication server. The way in which this flag is used will be explained later.

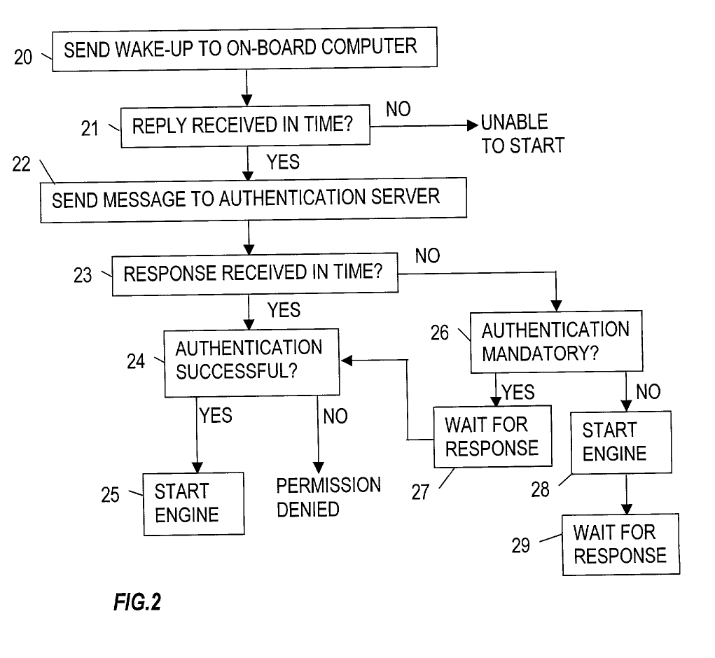

FIG. 2 shows the operation of the portable device 14 when it is inserted into the cradle 13 and switched on.

(Step 20) The portable device 14 first sends a “wake up” message to the on-board computer 11, requesting it to supply the vehicle identity.

(Step 21) The portable device then waits for the on-board computer to reply. If no reply is received within a predetermined time-out period (say five seconds), the device displays a message, informing the user that it is unable to start the vehicle. The device then reverts to a “normal” mode, in which it can be removed from the cradle and used for other purposes, as a conventional PDA.

(Step 22) If a reply is received from the on-board computer within the predetermined time-out period, the portable device 14 then sends an authentication request message to the authentication server 15, by way of the wireless network. The request message contains the following information:

the identity of the vehicle (supplied by the on-board computer in its reply);

the identity of the portable device, which is stored in non-volatile memory in the device;

the current geographical location of the device (obtained from the GPS receiver).

When the authentication server receives this message, it performs a number of authentication checks, as follows:

Whether the portable device is authorized for use with this vehicle.

Whether the vehicle is reported as being stolen.

Whether the vehicle is being used in an authorized time slot.

Whether the vehicle is being used in an authorized geographical area.

Whether the owner of the device has valid driving documentation.

The authentication server also checks whether any of the driving documentation is due to expire within a predetermined period (e.g. four weeks).

The authentication server then returns a response message to the portable device. This response contains: an indication of whether or not the authentication checks were successful;

the “authentication mandatory” flag for the vehicle;

a warning if any of the driving documentation is due to expire soon.

(Step 23) The portable device 14 waits for response from the authentication server.

(Step 24) If a response is received within a predetermined time-out period (say three seconds), the portable device determines from the response whether the authentication checks were successful. Also, the “authentication mandatory” flag returned by the server is passed to the on-board computer, which saves the flag in its local non-volatile memory.

If the authentication was not successful, a message is displayed, indicating that the user is denied permission to start this vehicle. The portable device then reverts to its “normal” mode.

(Step 25) If, on the other hand, the message indicates that the authentication was successful, the portable device sends a “go ahead” message to the on-board computer, allowing it to start the vehicle engine.

At the same time, the device displays to the user any warnings received about documentation that is due to expire soon. The device also provides the user with the facility for initiating the renewals process for any of the documentation. For example, if the vehicle insurance is due to expire shortly, the device may allow the user to send requests for quotations to one or more selected insurance brokers.

After the engine has started, the portable device enters a “drive” mode, in which it can perform a number of functions, including:

Displaying any maps or itineraries that have been generated in the device prior to the journey.

During the journey, displaying information about places of interest, places to eat etc., that conform to any preferences that may have been entered by the driver prior to the journey.

Receiving information from the on-board computer about distances or times before the next vehicle service is due. If a service is due, the device automatically sends a message over the wireless network to book the service, according to the driver's preferences.

Receiving and displaying traffic information.

Receiving e-mail and text messages. Messages cannot be read while the vehicle ignition is on, but may optionally be fed to a voice synthesis unit so that they can be spoken to the driver.

The portable device continues in this drive mode until it receives a signal from the on-board computer indicating that the vehicle engine has been switched off, whereupon the device reverts to its normal mode.

(Step 26) If, at step 23 above, the portable device does not receive any response from the authentication server within the predetermined time-out period, the device checks the vehicle's “authentication mandatory” flag, saved in the on-board computer.

(Step 27) If the “authentication mandatory” flag is set, the portable device is forced to wait for a response from the authentication server. When the response is eventually received, the engine is started, or else permission is denied device, depending on whether or not the authentication was successful.

(Step 28) If on the other hand the “authentication mandatory” flag is not set, the portable device sends a “go ahead” message to the on-board computer to start the engine, without waiting for a response from the authentication server. The device then enters the “drive” mode

(Step 29) Concurrently with the drive mode, the device waits for a response from the authentication server. If the response, when received, indicates that the authentication was not successful, the engine is allowed to continue running. (It would be dangerous to stop it). However, the authentication server sets the vehicle's “authentication mandatory” flag, to indicate that it is not permissible to start the vehicle again without receiving a successful response from the authentication server.

Thus, it can be seen that if there is a delay in authentication for any reason, the vehicle may be allowed to start without waiting for authentication. However, it will not be allowed to start the next time unless the authentication test is eventually successful.

### Some Possible Modifications

It will be appreciated that many modifications may be made to the system described above without departing from the scope of the present invention. For example, instead of being wired to the on-board computer by way of a cradle, the portable device may be coupled to the on-board computer by means of a wireless link (e.g. radio frequency or infrared).

1. A vehicle security method comprising:
(a) operating a portable device in the vehicle to obtain the identity of the vehicle, and then to send a message by a wireless connection to a remote authentication server computer, the message including the identity of the vehicle and also the identity of the portable device;
(b) operating the authentication server computer to perform a check that the portable device is authorized in relation to the vehicle, and then to return a response by the wireless connection to the portable device, indicating the result of the check; and
(c) operating the portable device, when it receives the response from the authentication server computer, and if the response indicates that the result of the check is satisfactory, to enable the vehicle to be started.

2. A vehicle security method according to claim 1 wherein the authentication server computer performs further checks including one or more of the following:
(a) whether the vehicle is reported as being stolen;
(b) whether the vehicle is being used in an authorized time slot;
(c) whether the vehicle is being used in an authorized geographical area;
(d) whether the owner of the device has valid driving documentation.

3. A vehicle security method according to claim 1 wherein the authentication server computer checks whether driving documentation relating to the owner of the device is due to expire within a predetermined time period and, if so, returns a warning to the portable device.

4. A vehicle security method according to claim 1, wherein, if the portable device does not receive a response from the authentication server computer within a predetermined timeout period, the portable device enables the vehicle to be started without having received a response.

5. A vehicle security method according to claim 4, wherein:
(a) the portable device continues to wait for a response after the portable device has enabled the vehicle to be started without having received a response; and
(b) if a response is eventually received indicating that the authentication check has failed, receipt of a response is made mandatory before the vehicle can be started again.

6. A vehicle security method according to claim 1 wherein the portable device communicates with the authentication server computer by way of a cellular radio telephone network.

7. A portable device for use in a vehicle security system, the portable device comprising:
(a) means for obtaining the identity of a vehicle in which the portable device is currently located;
(b) means for sending a message by a wireless connection to a remote authentication server computer, the message including the identity of the vehicle and also the identity of the portable device;
(c) means for receiving a response from the authentication server computer, indicating whether the portable device is authorized in relation to the vehicle; and
(d) means enabling the vehicle to be started if the response indicates that the result of the check is satisfactory.

8. A portable device according to claim 7, including means for enabling the vehicle to be started without waiting for the response in the event that the portable device does not receive a response from the authentication server computer within a predetermined timeout period.

9. A portable device according to claim 8, including means for continuing to wait for a response after the vehicle has been started without waiting for a response, and means for making receipt of a response mandatory before the vehicle can be started again if a response is eventually received indicating that the authentication check has failed.

10. A portable device according to claim 7, including means for communicating with an authentication server computer by way of a cellular radio telephone network.

11. A vehicle security method comprising:
(a) operating a security device in the vehicle to send a message by a wireless connection to a remote authentication server computer, requesting permission to activate the vehicle;
(b) in the event that the security device receives a favorable response from the authentication server computer within a predetermined timeout period, activating the vehicle;
(c) in the event that the security device receives an unfavorable response from the authentication server computer within the predetermined timeout period, preventing activation of the vehicle; and
(d) in the event that the security device does not receive any response from the authentication server computer within the predetermined timeout period, activating the vehicle without having received a favorable response.

12. A vehicle security method according to claim 11 wherein, when the vehicle has been activated without having received a favorable response, the security device continues to wait for a response and, if an unfavorable response is eventually received, a favorable response is made mandatory before the vehicle can be activated again.

13. A vehicle security device comprising:
(a) means for sending a message by a wireless connection to a remote authentication server computer, requesting permission to activate the vehicle;
(b) means for activating the vehicle upon receipt of a favorable response from the authentication server computer within a predetermined timeout period;
(c) means for preventing activation of the vehicle upon receipt of an unfavorable response from the authentication server computer within the predetermined timeout period; and
(d) means for activating the vehicle without having received a favorable response, in the event that no response is received from the authentication server computer within the predetermined timeout period.

14. A vehicle security device according to claim 13 further including:
(a) means for continuing to wait for a response when the vehicle has been activated without having received a favorable response; and
(b) means for making a favorable response mandatory before the vehicle can be activated again, in the event that an unfavorable response is eventually received.
